(19) United States
(12) Patent Application Publication
(10) Pub. No.: US 2009/0099913 A1
(43) Pub. Date: Apr. 16, 2009

(54) METHOD FOR PLACING AND DISTRIBUTING ADVERTISEMENTS OVER THE INTERNET

(76) Inventor: Peigen Jiang, Sammamish, WA (US)

Correspondence Address: PEIGEN JIANG, 19480 SE 28TH PLACE, SAMMAMISH, WA, 98075, US

(21) Appl. No.: 11/872,425

(22) Filed: Oct. 15, 2007

(51) Int. Cl. G06Q 30/00

(52) U.S. Cl. 705/14

(57) ABSTRACT

A method for placing and distributing advertisements over the Internet is disclose which comprises providing a website, verifying an advertiser's identity by the website, allowing the verified advertiser to place one or more advertisements by him or herself in the website, displaying the advertiser placed advertisements in categories in the website for viewing over the Internet, and allowing keyword searching of the advertisements in the website.

### BACKGROUND

The present invention relates generally to advertisement placement and distribution, and, more particularly, to placing and distributing advertisements over the Internet.

Advertisements are traditionally distributed over published materials, such as magazines and newspapers, or over broadcasting media, such as radio or television. A problem with the traditional advertisement distribution method is that the advertised materials are often being ignored and even regarded as nuisances, because people who receive those published or broadcasted materials are not intend to receive those advertised materials.

The Internet search engine based advertisement placement method offers an improvement over the traditional methods in that a person's interests are somehow revealed in his or her search keywords, and the distributed advertisements are linked to these keywords. However, great percentage of searches performed in a general search engine are not looking for product information, even they do, the search results may contain hundreds or even thousands of entries, and many of which are not that relevant. Because the search engine database is not just catered to the product information and may contain great deal of information in other aspects of these keywords.

As such, what is desired is method for providing advertisements to searching consumers whenever such information is wanted.

### SUMMARY

The present invention discloses a method for placing and distributing advertisements over the Internet. The method comprises providing a website, verifying an advertiser's identity by the website, allowing the verified advertiser to place one or more advertisements by him or herself in the website, displaying the advertiser placed advertisements in categories in the website for viewing over the Internet, and allowing keyword searching of the advertisements in the website.

The method may also comprise allowing consumers to post messages about the advertisements in the website. Besides, the method may allow a verified advertiser to alter his or her prior placed advertisement in the website at any time without involving anybody other than the verified advertiser.

The construction and method of operation of the invention, however, together with additional objects and advantages thereof, will be best understood from the following description of specific embodiments when read in connection with the accompanying drawings.

### BRIEF DESCRIPTION OF THE DRAWING

FIG. 1 is a block diagram illustrating a web based advertisement placement and distribution system according to one embodiment of the present invention.

FIG. 2 is a flow chart illustrating steps of placing and distributing advertisements over the Internet according to the embodiment of the present invention.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The following will provide a detailed description of a Web based system and method for placing advertisements in a website and distributing relevant advertisements by the website to searching consumers whenever such information is wanted. Advertisements, in general, refer to commercial messages promoting products or services, and are different from coupons which can be redeemed upon purchasing such products or services.

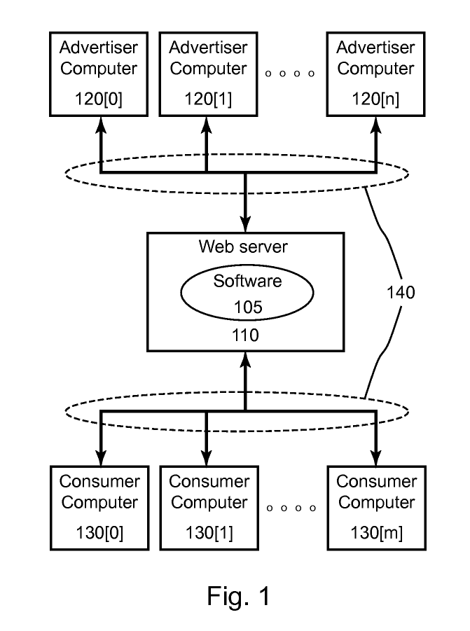

FIG. 1 is a block diagram illustrating a Web based advertisement placement and distribution system according to one embodiment of the present invention. The Web, or World Wide Web, is a hypertext system that operates over the Internet, used for serving Web pages and transferring files. The web based advertisement placement and distribution system comprises a software system 105 resides in a Web server 110. The software system 105 may generally called “website” that can be simultaneously accessed from a plurality of advertiser computers 120[0:n], as well as a plurality of consumer computers 130[0:m] through an Internet connection 140, where n and m are integers. The Web server 110 can be implemented by a variety of means including, for example, a Dell PowerEdge server computer running on Microsoft Windows Server operating system. The Web server 110 may also reside in multiple locations. The advertiser computers 120[0:n] are located at advertiser locations. The consumer computers 130[0:m] are located at consumer locations. Both the advertiser computers 120[0:n] and the consumer computers 130[0:m] most often run a Web browser, such as Microsoft Explorer, for communicating with the Web server 110. The computers 120[0:n] and 130[0:m] and the Web server 110 forms a client-server computer architecture.

The software system 105 allows an advertiser to place advertisement within the software system 105 through an advertiser computer 120[i], where 0≦i≦n, without human intervention from the Web server 110 side. This may involve the advertiser's selecting one or more product or service categories provided by the software system 105. The advertiser may also enter some keywords to facilitate search operations. The advertiser can then upload a prior-created advertisement to the Web server 110 from the advertiser computer 120[i]. The prior-created advertisement may be an illustration, an audio message or a video clip. The vendor can also specify when or in which part of the software system 105 the advertisement will appear.

In order to prevent false advertisement placement, the software system 105 verifies an advertiser's identity before allowing the advertiser to access the advertisement placement function thereof. Such verification may involve the advertiser's pre-registration and a sign-in by the pre-registered advertiser. With this verification system in place, a pre-registered advertiser can manage his or her account, i.e., altering his or her prior placed advertisements, at any time.

The placed advertisement will then be displayed on the software system 105 in selected categories and at the advertiser specified time. A consumer may view the advertisement by browsing through the categories or by keyword searching from a consumer computer 130[j], where 0≦j≦m, through a Web browser therein. Apparently, the advertiser can also view the advertisement from the advertiser computer 120[i]. In fact, any Internet connected computer can serve as either the consumer computer 130[i] or the advertiser computer 120[i]. When accessing advertisement viewing functions of the software system 105, the Internet connected computer is a consumer computer. When accessing advertisement placing function of the software system 105, the Internet connected computer is an advertiser computer. A skilled artisan may also realize that the presently disclosed Web based advertisement placement and distribution system allows multiple client computers 120 and 130 to access the Web server 110 simultaneously.

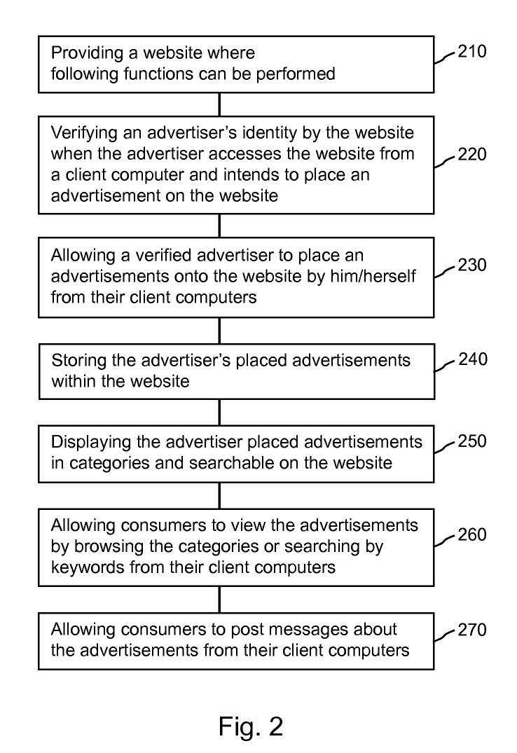

FIG. 2 is a flow chart illustrating steps of placing and distributing advertisements over the Internet according to the embodiment of the present invention. In step 210, an advertising service provider provides a website where advertisers can place advertisements therein. The advertiser self placed advertisements are then displayed in the website. Consumers can view the advertisements by accessing the website. However, before being allowed to place an advertisement, an advertiser needs to have its identity verified in step 220. Verifying advertiser's identity is to prevent fraudulent advertisement placement. The verifying process may involve a pre-registration and comparing with the pre-registered information during each access by the advertiser thereafter. The pre-registration may require the advertiser who intend to place and distribute advertisements for products or services on the website to set up an account by providing proves of ownership of the products or services. The setting up account may include entering an account name and password, which can then be used for verifying purpose during subsequent accessing the website by the advertiser.

Step 230 shows that the website allows a verified advertiser to place an advertisement within the website by him or herself from a client computer. The advertisement placement process may include template selection, text editing, file uploading and layout editing. The uploaded file may be prior created advertising messages in illustration, audio or video format. A skilled artisan will have no difficulties to write software for the website to perform such functions. Therefore, there will be no need for persons other than the advertiser's personnel to participate in the advertisement placement process.

The website allows the verified advertiser to store the placed advertisements in the website in step 240. The verified advertiser can also decide in which categories, having what searchable keyword, when and for how long the placed advertisements will be displayed on the website in step 250. In another embodiment of the present invention, the step 250 may also include that the website allows the verified advertiser to alter or even entirely cancel the displayed advertisements at any time.

Step 260 shows that the website allows consumers to view the advertisements by browsing the categories or searching by keywords from their client computers. The website may also allow consumers to post messages about the advertisements from their client computers in step 270. In this case, the advertiser may leave some checking criteria for the website to verify that a person who wants to post a message about an advertisement is indeed a purchaser of the product or service.

A skilled artisan would also realize that the steps 240, 250, 260 and 270 described above can be executed by the website through software without human participation on the web server side. The advertisement placement and distribution system and method of the present invention give advertisers full control of the advertisement placement and distribution process at all time.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for placing and distributing advertisements, the method comprising:
providing a website;
verifying an advertiser's identity by the website;
allowing the verified advertiser to place one or more advertisements by him or herself in the website;
displaying the advertiser placed advertisements in categories in the website for viewing over the Internet; and
allowing keyword searching of the advertisements in the website.

2. The method of claim 1, wherein the verifying includes:
pre-registering an advertiser's information; and
comparing with the pre-registered information during the advertiser's later access of the website.

3. The method of claim 1, wherein the allowing the verified advertiser to place one or more advertisements comprises providing template selection, text editing, file uploading and layout editing.

4. The method of claim 3, wherein the file uploading includes uploading audio and video clips.

5. The method of claim 1 further comprising storing the advertiser placed advertisements in the website.

6. The method of claim 1 further comprising:
allowing the verified advertiser to specify conditions of the advertisement displaying in the website; and
executing the advertisement displaying by the website according to the specified conditions without human participation.

7. The method of claim 6, wherein the conditions of the advertisement displaying include a start time and an end time of the advertisement displaying.

8. The method of claim 1 further comprising allowing consumers to post messages about the advertisements in the website.

9. The method of claim 8 further comprising verifying identities of the consumers who intend to post messages.

10. The method of claim 1 further comprising allowing a verified advertiser to alter his or her prior placed advertisements in the website at any time without involving anybody other than the verified advertiser.

11. A method for placing and distributing advertisements, the method comprising:
providing a website;
verifying an advertiser's identity by the website;
allowing the verified advertiser to place one or more advertisements by him or herself in the website;
displaying the advertiser placed advertisements in categories in the website for viewing over the Internet;
allowing keyword searching of the advertisements in the website; and
allowing consumers to post messages about the advertisements in the website.

12. The method of claim 11, wherein the verifying includes:
pre-registering an advertiser's information; and
comparing with the pre-registered information during the advertiser's later access of the website.

13. The method of claim 11, wherein the allowing the verified advertiser to place one or more advertisements comprises providing template selection, text editing, file uploading and layout editing.

14. The method of claim 13, wherein the file uploading includes uploading audio and video clips.

15. The method of claim 11 further comprising storing the advertiser placed advertisements in the website.

16. The method of claim 11 further comprising:
Allowing the verified advertiser to specify conditions of the advertisement displaying in the website; and
executing the advertisement displaying by the website according to the specified conditions without human participation.

17. The method of claim 16, wherein the conditions of the advertisement displaying include a start time and an end time of the advertisement displaying.

18. The method of claim 11 further comprising verifying identities of the consumers who intend to post messages.

19. The method of claim 1 further comprising allowing a verified advertiser to alter his or her prior placed advertisements in the website at any time without involving anybody other than the verified advertiser.
